(19) United States
(12) Patent Application Publication
(10) Pub. No.: US 2007/0171027 A1
(43) Pub. Date: Jul. 26, 2007

(54) BIOMETRIC ANTI-THEFT SYSTEM AND METHOD

(75) Inventor: Richard S. Slevin, Los Altos, CA (US)

Correspondence Address: PATENT LAW OFFICES OF MICHAEL E. WOODS, 3433 WHEELING DRIVE, SANTA CLARA, CA, 95051, US

(73) Assignee: ODI SECURITY; LLC, Mountain View, CA (US)

(21) Appl. No.: 11/307,137

(22) Filed: Jan. 25, 2006

(51) Int. Cl. G05B 19/00

(52) U.S. Cl. 340/5.52

(57) ABSTRACT

An apparatus, method, and computer program product for a biometric power tool. The biometric power tool includes: a portable power tool having an electric motor operable in response to a current flow from a power supply to the electric motor; a power control system, interposed between the electric motor and the power supply and responsive to a biometric control signal, for selectively enabling the current flow to the electric motor in an enable-mode when the biometric control signal is asserted and for selectively disabling the current flow to the electric motor in a disable mode when the biometric control signal is deasserted; and a biometric system, coupled to the power control system, for obtaining a biometric profile of a user and comparing the biometric profile against a set of validated users, the biometric system setting the biometric control signal responsive to a validation of the biometric profile against the set of validated users to control the modes wherein the electric motor is inoperable when the biometric profile is not validated and wherein the electric motor is operable when the biometric profile is validated.

### BACKGROUND OF THE INVENTION

The present invention is related to biometric systems, and more particularly to biometric systems for securing portable electric devices, particularly those relying on line power through a power cord.

Locations where portable electric devices using line power are found in abundance is construction sites. Builders and developers commonly employ many different power tools on each work site and a universal concern is theft of these tools. Common anti-theft solutions include containing the tools in a controlled-access area when workers are not on-site as well as packing up the tools at the conclusion of each work day and removing them from the site.

The packing/unpacking and area access control solution contributes to inefficiency in the construction process. Additionally it is sometimes the case that persons authorized to use the tools in one context may acquire them and use them in unauthorized situations.

Biometric systems are known for developing a user profile and authorizing some activity when the user profile sufficiently matches some screening test. The nature of the profiles, activity, screening test, and match threshold vary widely.

Thus what is needed is a security system that controls use of power tools in a manner that does not interfere with their use while inhibiting theft and/or unauthorized use.

### BRIEF SUMMARY OF THE INVENTION

Disclosed is an apparatus, method, and computer program product for a biometric power tool. The biometric power tool includes: a portable power tool having an electric motor operable in response to a current flow from a power supply to the electric motor; a power control system, interposed between the electric motor and the power supply and responsive to a biometric control signal, for selectively enabling the current flow to the electric motor in an enable-mode when the biometric control signal is asserted and for selectively disabling the current flow to the electric motor in a disable mode when the biometric control signal is deasserted; and a biometric system, coupled to the power control system, for obtaining a biometric profile of a user and comparing the biometric profile against a set of validated users, the biometric system setting the biometric control signal responsive to a validation of the biometric profile against the set of validated users to control the modes wherein the electric motor is inoperable when the biometric profile is not validated and wherein the electric motor is operable when the biometric profile is validated.

The method includes scanning a biometric profile using a hand-operated power tool and using the biometric profile to control enablement/disablement of an electric motor of the power tool. The computer program product includes instructions for controlling a power tool when implemented on a computing system incorporated into the power tool, the instructions implementing the method described above.

Providing a power tool with biometric qualification enhances security and reduces risk of unauthorized use in a simple and efficient manner. Systems, method, and computer program products may be implemented in several different ways to selectively authorize use and operation to inhibit theft or unauthorized use.

### BRIEF DESCRIPTION OF THE DRAWINGS

FIG. 1 is a schematic block diagram of a preferred embodiment of the present invention for a biometric-switched power tool.

### DETAILED DESCRIPTION OF THE INVENTION

The preferred embodiments of the present invention relate to an efficient biometric-switched power tool, system, and method solution that provides a simple and efficient security system that controls use of power tools in a manner that does not interfere with their use while inhibiting theft and/or unauthorized use. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments shown but is to be accorded the widest scope consistent with the principles and features described herein.

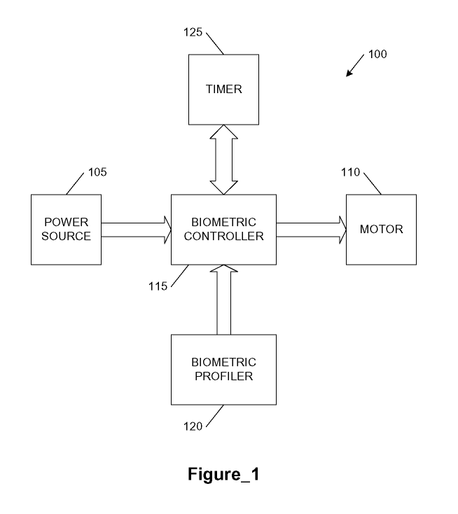

FIG. 1 is a schematic block diagram of a preferred embodiment of the present invention for a biometric-switched power tool 100. Tool 100 includes a power source 105, a motor 110, a biometric controller 115, a biometric profiler 120, and an optional timer 125. Tool 100 includes easily ported devices (e.g., circular saws, electric drills, and the like) as well as powered devices that may be moved with some effort (e.g., table saws, air compressors, and the like).

Power source 105 includes line power from a power outlet (e.g., 112/220V) and may include a regulator, transformer, power conditioner and other similar well-known components and portable power sources like a battery or electric-current producing fuel cell or the like. Power source 105 provides a source of voltage, current, power or the like to energize motor 110. Additionally, motor 105 is, in the preferred embodiment, incapable of operation without the output of power source 105. Motor 105 includes alternating current motors and direct current motors. Additionally, in some embodiments motor 105 may be an electronic circuit including a microprocessor, microcontroller or other controller for performing processing/computing tasks dependent upon the output of power source 105 for operation—thus in essence a “computer” motor.

Biometric controller 115 uses a biometric profile produced from biometric profiler 120 to determine whether the person associated with the biometric profile is authorized for some type of operation of motor 110, and when authorized, the appropriate operation of motor 110 results by gating the necessary output from power source 105 to motor 110. There are many types of biometric systems now known and implemented, as well as those being implemented including fingerprint scanners, retinal scans, voice pattern and the like that produce an appropriate profile of a user using an appropriate scanning system and that they use various algorithms, pattern-matching, and thresholds to determine access/authorization levels or rights. Some systems are access granted/denied systems while others provide varying access rights after matching a profile to a particular person in a database. Controller 115 and profiler 120 may be adapted to use any of these biometric systems as appropriate to the embodiment, implementation, and situation.

Optional timer 125 cooperates with biometric controller 115 to provide operational periods following a successful authorization after which a new authorization event or a period extension event is required.

For the following operational example, tool 100 will be described as an electric drill to simplify the discussion—though as explained herein other tools and tool types are included within the scope of the present invention. This drill is part of the equipment available to workers at a construction site when they arrive in the morning. After enabling power source 105, such as by plugging the drill into a power outlet or inserting charged batteries, the drill is inoperative until it detects an authorization event. This authorization event in this case is for an authorized user, for example a supervisor, to interface with profiler 120 and submit a validatable profile to biometric controller 115. Up until the validatable profile is submitted, motor 110 is wholly without power and the drill is inoperable. Upon detecting the validatable profile, controller 115 enables the power-on mode for the electric drill and the user may thereafter use the drill in normal fashion for a particular period. That period may be one or both of two independent termination events: a) expiration of a timer; or b) unplugging/removing power to power source 105. Timer 125 may also be used to terminate operational mode (and thereafter require an new authorization or extension event) in the event that the drill is inactive longer than a predetermined inactivity threshold.

Upon occurrence of one of these events, the drill becomes inoperative unless and until a new authorization event occurs. The timer may be set for the standard work day, say for example eight hours. Thus the electric drill functions regularly for eight hours following the authorization. Similarly, in some embodiments the drill is operative after authorization unless and until the drill is unplugged. When it is plugged in again, the authorization event may need to be repeated.

Some embodiments employing both termination events may incorporate these events as an either/or event (e.g., the drill ceases to work when either the timer expires or after the drill is unplugged, whichever occurs first). Other embodiments may implement these events as an AND event—the drill ceases to work upon the second to occur of the events (e.g., the drill keeps working after expiration of the timer as long as it remains plugged in; or the drill keeps working after being unplugged and replugged as long as the timer has not expired). Once the first event has occurred, the occurrence of the second terminates operation until another authorization event is detected.

In still other embodiments, it is possible to require an extension event after occurrence of a terminating event/events condition. For example, the workers may have profiles added to the drill so that they may extend the operational period (for example an hour or until unplugged again or combination thereof) one time, or for a present but limited number of times until the authorization must be provided again.

Thus in this configuration, the electric drill is useable throughout the day, once use is authorized. The workers are not inconvenienced by the system which enhances security and safety by only working once an authorized user enables the system. The drill may be left on-site overnight with reduced risk of theft or unauthorized use. The user may post signs advising other persons happening on the site that the equipment is so-protected and the tool is worthless to them without enablement by the authorized user.

The system, method, computer program product, and propagated signal described in this application may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the preferred implementations of the present invention is as a routine in an operating system made up of programming steps or instructions resident in a memory of a computing system shown in FIG. 2, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. An biometric-power tool, comprising:
a portable power tool having an electric motor operable in response to an output from a power supply to said electric motor;
a power control system, interposed between said electric motor and said power supply and responsive to a biometric control signal, for selectively enabling said output to said electric motor in an enable-mode when said biometric control signal is asserted and for selectively disabling said output to said electric motor in a disable mode when said biometric control signal is deasserted; and
a biometric system, coupled to said power control system, for obtaining a biometric profile of a user and comparing said biometric profile against a set of validated users, said biometric system setting said biometric control signal responsive to a validation of said biometric profile against said set of validated users to control said modes wherein said electric motor is inoperable when said biometric profile is not validated and wherein said electric motor is operable when said biometric profile is validated.

2. The biometric-power tool of claim 1 further comprising a timer, coupled to said biometric system and to said power control system, for asserting said biometric control signal for a predetermined period after a successful validation to enable said output to said electric motor during said predetermined period, said timer deasserting said biometric control signal at an expiration of said predetermined period to disable any ouptut to said electric motor.

3. The biometric-power tool of claim 1 wherein said power supply is a line source communicated to said electric motor through a power cord coupled to said line source.

4. The biometric-power tool of claim 1 wherein said power supply is a battery source communicated to said electric motor.

5. An apparatus, comprising:
a power source for providing an output;
a motor operable upon an application of said output;
a biometric profiler for producing a biometric profile of a prospective operator of said motor; and
a biometric controller, responsive to biometric profile, for applying selectively said output to said motor upon an authorization event wherein said biometric profile sufficiently matches an authorized operator, said biometric controller disabling said application of said output to said motor until said authorization event.

6. The apparatus of claim 5 wherein said biometric controller disables said application of said output upon a termination event.

7. The apparatus of claim 6 wherein said termination event includes expiration of a timer started upon said authorization event.

8. The apparatus of claim 6 wherein said power source provides said output from a power input to a power generator and termination event includes an interruption of said power input.

9. The apparatus of claim 8 wherein said power generator is a power socket and said power input is provided via a power cord wherein said interruption includes unplugging said power cord from said power socket.

10. The apparatus of claim 6 wherein said power source provides said output from a power input to a power generator and wherein said termination event is selected from the events group consisting essentially of one or more of expiration of a timer started upon said authorization event, an interruption of said power input, and combinations thereof.

11. The apparatus of claim 10 wherein said termination event occurs upon a first detection of one of said events.

12. The apparatus of claim 10 wherein said termination event occurs upon one of said events following occurrence of the other of said events.

13. An biometric-power tool, comprising:
a portable power tool having an electric motor operable in response to a current flow from a power supply to said electric motor;
a power control system, interposed between said electric motor and said power supply and responsive to a biometric control signal, for selectively enabling said current flow to said electric motor in an enable-mode when said biometric control signal is asserted and for selectively disabling said current flow to said electric motor in a disable mode when said biometric control signal is deasserted;
a biometric system, coupled to said power control system, for obtaining a biometric profile of a user and comparing said biometric profile against a set of validated users, said biometric system setting said biometric control signal responsive to a validation of said biometric profile against said set of validated users to control said modes wherein said electric motor is inoperable when said biometric profile is not validated and wherein said electric motor is operable when said biometric profile is validated; and
a timer, coupled to said biometric system and to said power control system, for asserting said biometric control signal for a predetermined period after a successful validation to enable said current flow to said electric motor during said predetermined period, said timer deasserting said biometric control signal at an expiration of said predetermined period to disable any current flow to said electric motor.

14. A method, comprising:
a) obtaining a biometric profile from a user;
b) comparing said biometric profile against a set of valid biometric profiles;
c) asserting an authorization event when said biometric profile sufficiently matches an authorized operator of a portable, electrically powered tool; and
d) enabling an application of an output of a power source to operating components of said tool only upon assertion of said authorization event, until then said operating components are inoperable.

15. The method of claim 14 further comprising:
e) disabling said application of said output upon occurrence of a termination event after said authorization event.

16. The method of claim 15 wherein said power source accesses power from a power outlet via a power cord coupled to a power outlet, said termination event includes unplugging said power cord from said outlet.

17. The method of claim 15 wherein said termination event includes expiration of a timer, said timer upon said authorization event.
